(19) United States
(12) Patent Application Publication
(10) Pub. No.: US 2007/0239735 A1
(43) Pub. Date: Oct. 11, 2007

(54) Systems and methods for predicting if a query is a name

(76) Inventors: Eric J. Glover, North Brunswick, NJ (US); Apostolos Gerasoulls, Edison, NJ (US); Vadim Bich, Highland Park, NJ (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/399,583

(22) Filed: Apr. 5, 2006

(51) Int. Cl. G06F 17/30

(52) U.S. Cl. 707/10

(57) ABSTRACT

A system and method for predicting if a query is a name is provided. The method begins by providing an input query. A name database, having a list of names, famous names and queries that are known to not be a name is searched to determine if the input query is a name, a famous name or not a name. If the query is not located in the name database, the query is processed through a “looks like a name” function to determine if the query is a name. Systems and methods for classifying word strings as names, not names, and famous names are also provided. Systems and methods for creating name databases are also provided.

### FIELD OF THE INVENTION

The invention relates to the field of search engines and, in particular, to natural language searching systems and methods.

### BACKGROUND OF THE INVENTION

The Internet is a global network of computer systems and websites. These computer systems include a variety of documents, files, databases, and the like, which include information covering a variety of topics. It can be difficult for users of the Internet to locate this information on the Internet, so users often query search engines to locate this information.

For the search engine to more accurately locate information on the Internet, it may be useful to determine whether the query is or contains a person's name. Currently, there are a few basic approaches to identify if the query is or contains a person's name. The first approach includes simple, fixed lists, such as a list of first names and a list of last names, and a simple rule, in which the query is a name if it is a first name followed by a last name. A second approach considers the context around text to predict if a certain component of the text is likely a name to build a list of names. A third approach uses classification.

However, the first approach is not capable of recognizing names that do not look like a name, such as, for example, “Usher” or “50 Cent” or “Attila the Hun.”

In addition, there is a trade-off in the first approach between the coverage and the precision of the first and last names lists. For example, if “Alexander” is included in the last name list, then a query for “Brandy Alexander” might be considered a name by the search engine; however, searches for “Brandy Alexander” are typically used to get information about an alcoholic drink.

The contextual (second) approach also has disadvantages. First, if a static list is generated, names not in the training corpus are not recognized as names. Second, if a lower precision algorithm is used, many bad names are found, and if a higher precision algorithm is used, many legitimate names are missed. Third, the creation of even a small list of names using a contextual analysis is a slow and complex process: it can take weeks or months to screen terabytes of text.

With the classification (third) approach, there are many possible sources of data, including web results or other sources, and several operations are required. Given a query, the set of data must be attained, featurized and classified. However, too much time is required for a high performance web search engine to perform these operations in real time. It is also difficult to include human knowledge in the classification approach. In addition, the classifier may have problems with queries if there is no data or the data quality is poor.

### SUMMARY OF THE INVENTION

The invention provides a method of predicting if a query is a name, which includes receiving a query; searching a name exception database; determining the query is a name if a match for the query is located in the name database; and if the query is not located in the name exception database, determining if the query looks like a name, utilizing simple lists.

The invention also provides a method for generating a name exception database, which includes storing a list of known names; adding search queries known to be names to the list of known names; and storing a list of known non-names.

The invention further provides a method for determining if a query looks like a name, which includes providing at least one query; providing at least one web result for the at least one query; analyzing the web results; and generating features for the at least one query.

The invention further provides a method of classifying a name database, which includes determining if a query looks like a name; if the query looks like a name, determining if the query is famous; and if the query looks like a name and is famous, then indexing the query as a famous name.

### BRIEF DESCRIPTION OF THE DRAWINGS

The invention is described by way of example with reference to the accompanying drawings, wherein:

FIG. 1 is a block diagram illustrating a system for reviewing search queries for a name in accordance with one embodiment of the invention;

FIG. 2 is a block diagram illustrating a system for predicting if a query/string is a name in accordance with one embodiment of the invention;

FIG. 3 is a process flow diagram showing a method for determining if a query/string looks like a name in accordance with one embodiment of the invention;

FIG. 4 is a process flow diagram showing a method for compressing a fast names exception database in accordance with one embodiment of the invention;

FIG. 5 is a process flow diagram showing a method for determining if an input is a name in accordance with one embodiment of the invention;

FIG. 6 is a process flow diagram showing a method for creating the fast names exception database of FIG. 2 in accordance with one embodiment of the invention;

FIG. 7 is a process flow diagram showing a method for correcting the fast names exception database, the “looks like a name” function, and classification system of FIG. 2 in accordance with one embodiment of the invention;

FIG. 8A is a process flow diagram showing a method for deleting an input from a last name list in accordance with one embodiment of the invention;

FIG. 8B is a process flow diagram showing a method for deleting an input from a first name list in accordance with one embodiment of the invention; and

FIG. 9 is a process flow diagram showing a method for adding names to a list in accordance with one embodiment of the invention.

### DETAILED DESCRIPTION

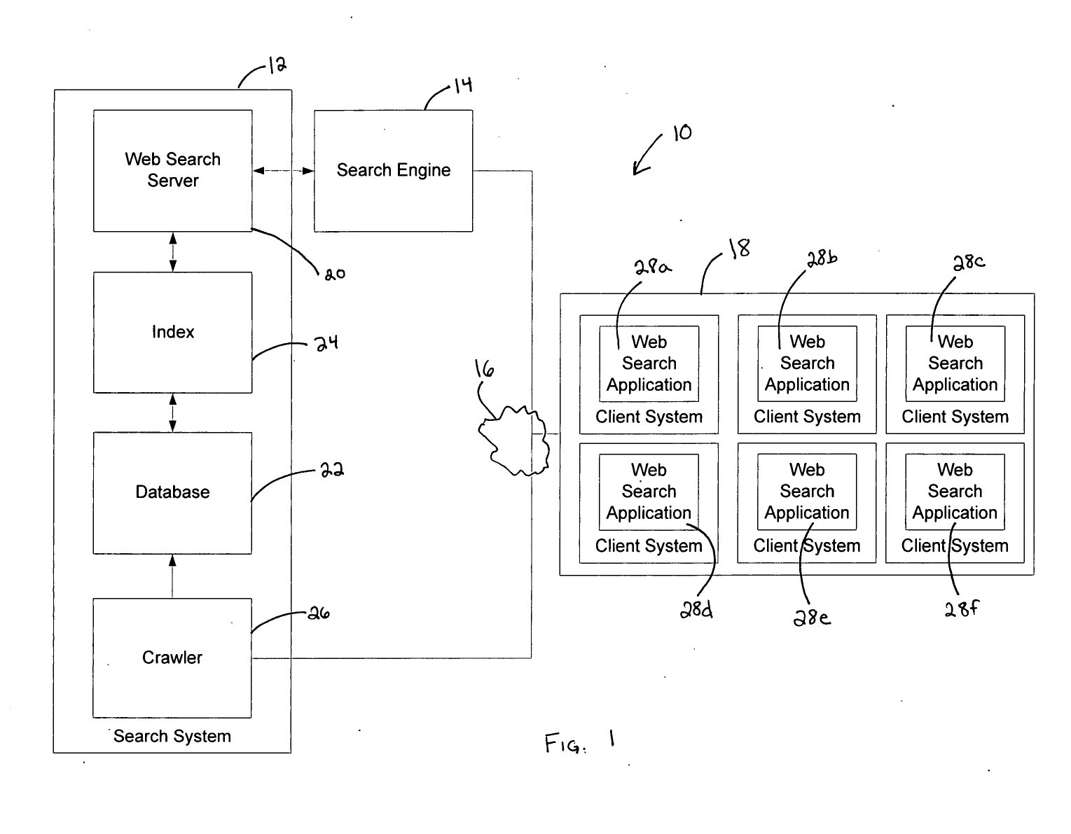

FIG. 1, of the accompanying drawings, shows a network system 10 which can be used in accordance with one embodiment of the present invention. The network system 10 includes a search system 12, a search engine 14, a network 16, and a plurality of client systems 18. The search system 12 includes a server 20, an index 22, an indexer 24 and a crawler 26. The plurality of client systems 18 includes a plurality of web search applications 28a-f, located on each of the plurality of client systems 18.

The server 12 is connected to the search engine 14. The search engine 14 is connected to the plurality of client systems 18 via the network 16. The server 20 is in communication with the database 22 which is in communication with the indexer 24. The indexer 24 is in communication with the crawler 26. The crawler 26 is capable of communicating with the plurality of client systems 18 via the network 16 as well.

The web search server 20 is typically a computer system, and may be an HTTP server. It is envisioned that the search engine 14 may be located at the web search server 20. The web search server 20 typically includes at least processing logic and memory.

The indexer 24 is typically a software program which is used to create an index, which is then stored in storage media. The index 22 is typically a table of alphanumeric terms with a corresponding list of the related documents or the location of the related documents (e.g., a pointer). An exemplary pointer is a Uniform Resource Locator (URL). The indexer 24 may build a hash table, in which a numerical value is attached to each of the terms. The index 22 is stored in a storage media, which may be volatile or non-volatile memory that includes, for example, read only memory (ROM), random access memory (RAM), magnetic disk storage media, optical storage media, flash memory devices and zip drives.

The crawler 26 is a software program or software robot, which is typically used to build lists of the information found on Web sites. Another common term for the crawler 26 is a spider. The crawler 26 typically searches Web sites on the Internet and keeps track of the information located in its search and the location of the information.

The network 16 is a local area network (LAN), wide area network (WAN), a telephone network, such as the Public Switched Telephone Network (PSTN), an intranet, the Internet, or combinations thereof.

The plurality of client systems 18 may be mainframes, minicomputers, personal computers, laptops, personal digital assistants (PDA), cell phones, and the like. The plurality of client systems 18 are characterized in that they are capable of being connected to the network 16. Web sites may also be located on the client systems 18. The web search application 28a-f is typically an Internet browser or other software.

In use, the crawler 26 crawls websites, such as the websites of the plurality of client systems 18, to locate information on the web. The crawler 26 employs software robots to build lists of the information. The crawler 26 may include one or more crawlers to search the web. The crawler 26 typically extracts the information and stores it in the database 22. The indexer 24 creates an index of the information stored in the database 22.

When a user of one of the plurality of client systems 18 enters a search on the web search application 28, the search is communicated to the search engine 14 over the network 16. The search engine 14 communicates the search to the server 20 at the search system 12. The server 20 accesses the index and/or database to provide a search result, which is communicated to the user via the search engine 14 and network 16.

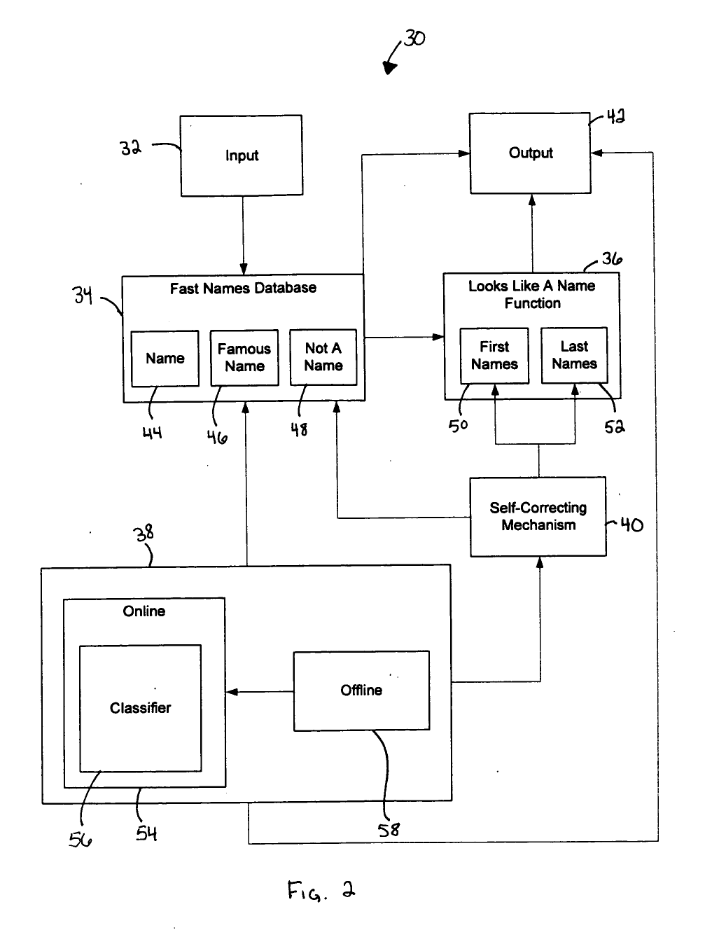

FIG. 2 shows a system 30 which can be used to determine if any input received is a name. The system 30 is typically located at the server 20 (See FIG. 1).

The system 30 includes an input 32, a fast names exception database 34, a “looks like a name” function 36, a classification system 38, a self correcting mechanism 40, and an output 42.

The fast names exception database 34, “looks like a name” function 36, and the classification system 38 are each used to improve the data files of the other and are, therefore, connected with each other through the data files. The self correcting mechanism 40 uses the classification system 38 to correct the fast names exception database 34 and the lists used by the “looks like a name” function 36. The fast names exception database 34, “looks like a name” function 36, classification system 38, or combinations thereof, can be used to create the output 42.

In one embodiment, the input 32 is a search query received from a user of the search system 12 (See FIG. 1). However, the input may not necessarily be a search query. For example, the input 32 may include words extracted from web documents. Alternatively, the input 32 may be a list of topics related to a search query (e.g., from the Ask Jeeves related search product), which need to be classified. The system 30 can determine if the initial query is a name and can also determine whether any of the related search topics are names. For example, if the search query is “Abraham Lincoln”, the system 30 determines that a first related topic, the Emancipation Proclamation, is not a name, but that a second related topic, Robert E. Lee, is a name.

The fast names exception database 34 includes a list of names 44, a list of famous names 46, and a list of not names 48. Alternatively, database 34 includes several strings (or queries), each of which has a value or label associated therewith. In one embodiment, the labels are “1”, “0” or “f”, wherein 1 means that the string is a name, 0 means that the word is not a name and f means that the word is a famous name. Thus, all of the strings that are names have a label or value of 1 associated therewith. Similarly, all of the strings that are famous names have a label or value of f associated therewith, and all of the strings that are not names have a label or value of 0 associated therewith. It will be appreciated that the list of names 44, list of famous names 46 and list of not names 48 may also have the labels associated therewith.

The fast names exception database 34 may be built from many sources, including the classification system offline classifier 58, editorially collected lists, such as a list of baseball players, and other collections. It will be appreciated that the fast names exception database 34 may be built by compressing the lists, as described hereinafter.

The “looks like a name” function 36 includes at least a first names list 50 and a last names list 52. The “looks like a name” function 36 may also include other predefined lists, such as, for example, a list of prefixes, a list of suffixes, and a list of other name or filter words, such as “pictures” and “biography,” a special middle names only list, such as “der” and “von,” a middle initials list and the like (not shown).

Special filtering rules may also be included in the “looks like a name” function 36. For example, one special filter rule may be if a query includes more than five words, then the query is never a name. Another exemplary special filter rule may be that queries beginning with the phrase “who is” or “what is” will return an answer of false or “not a name.”

The “looks like a name” function 36 or the system 30 is an algorithm which determines whether the input 32 has the form of a name. The “looks like a name” function 36 uses a set of predefined templates based on the total number of words in the query, as will be described hereinafter.

The classification system 38 includes an online version 54, which includes a classifier 56, and an offline version 58. The classification system 38 is a software program that uses machine learning and the classifier 56 to determine whether the input is a famous name, non-famous name or not a name. It will be appreciated that the input may be classified in other ways, such as by using predefined lists and query information to determine whether the input is, for example, a famous name.

The input to the classification system 38 includes the input 32, original queries which may include actual user queries from a search engine, queries that are deemed important through data analysis over time and are likely to be names, bigrams extracted from the web where both words are capitalized, and the like.

The self-correcting mechanism is a software program which is used to improve the accuracy of the lists used by the “looks like a name” function, as well as to improve the accuracy of the classifier.

The output 42 is a result for the query and typically is in the form of a label: 0, 1 or f.

In use, the system 30 runs an algorithm to determine if the input 32 is a name (i.e., fast names algorithm). First, the fast names exception database 34 is searched to determine if the input string or query 32 is included in the fast names exception database 32. The fast names exception database 34 receives the input 32. If it is in the fast names exception database 34, the answer will be 1, f, or 0 (i.e., 1 is a name, f is a famous name, and 0 is not a name). The answer is sent to the output 42. If the input 32 is not defined in the fast names exception database 34, then the input 32 goes to the “looks like a name” function 36.

When the input 32 is received at the “looks like a name” function 36, the “looks like a name” function 36 uses the lists of first names, last names, and other simple lists, such as lists of prefixes and suffixes, to determine if the form of the input 32 is in the form of a name. If the “looks like a name” function 36 determines that the input string or query 32 is a name, then the “looks like a name” function 36 returns a value of 1 (i.e., the input is a name). If the “looks like a name” function determines that the input string or query is not a name, it returns a value of 0 (i.e., the input is not a name). The returned value is sent to the output 42.

The names in the fast names exception database 34 are stored as a simple hash which includes values of either 0, 1, or f. If a query is not defined in the fast names exception database, then it is checked by the “looks like a name” function 36. The “looks like a name” function 36 involves a linear pass across each word in the query to check if each corresponding query term is on a predefined set of lists (a single hash can be used where the query word is the key, and the value is the set of lists which contain that word), and a very fast scan of the results of the hash lookup.

As discussed above, the fast names exception database 34 can be built by combining the “looks like a name” function 36 and the classification system 38 output. The “looks like a name” function 36 determines if the basic query follows a pattern suggesting that it is likely a name, such as, for example, a first-name followed by a last-name. If the query is not a name and it does not look like a name, then it is skipped (i.e., the query is not stored in the database). If the query is not a name and it looks like a name, then it is appended to the fast names exception database file and the label 0 is applied, meaning the query is not a name. If the query is famous, then it is appended to the fast names exception database file and a label f is applied, meaning that the query is famous. If the query is a name and is not famous and it looks like a name, then it is skipped. That is, some names will not be stored in the fast names exception database 34 because the subsequently run “looks like a name” function 36 will identify the name as a name, thereby minimizing the number of names needed to be stored in the fast names exception database 34. If the query is a name and is not famous and does not look like a name, then it is appended to the fast names exception database file and the label 1 is applied, meaning it is a name, but is not famous. The above process effectively builds the exception list of the fast names exception database. This typically results in a highly compressed database (removing many entries); however, the output appears the same (as if every processed query were in the database).

The classification system predicts if the query is a name or not a name for each input query received when building the fast names exception database 34. The offline version 58 of the classification system uses machine learning to learn how to classify the input. The online version 54 and the classifier 56 use the output of the offline version 58 to actually classify input.

The classification system 38 and the classifier 56 work as follows: each query is submitted to the live site, the top 20 results are then used to form features for this query. The top 20 titles, top 20 URLs, and top 20 descriptions as well as the query itself are used. Any provided lists, including lists of first names, last names, name prefixes, name suffixes, role words, stop words, verbs, dictionary words, and the like are used to generate features from the available data. The available data includes titles, summaries, URLs, and the query itself. Any other information can be added such as knowledge about particular URLs, parts of speech tagging, and the like. Custom special conceptual features may also be added such as “does the query look like a name,” “date parsing,” “special punctuation parsing,” and “matching individual query words to the text.” A chart parser may be used to capture all possible parses of the results. A SVM (Support Vector Machine) polynomial kernel function may also be used. The classifier training is typically set towards higher precision.

The results of the classifier 56 are then used to produce a special file where each query is listed with a label: 0 (i.e., not a name), 1 (i.e., name), or f (i.e., famous name). Supplemental lists may then be used to produce additional files.

By examining the frequency of a query (or string), either on the web or received as a user query, the classification system 38 can predict if a string is famous.

By examining the context of a query and its web results, the classification system 38 can predict if a query is likely a name. For example, the query “San Francisco” looks like a name. “San” could be a first name and “Francisco” could be a last name. However, most of the web results for “San Francisco” are about travel, commercial, or governmental interests. Thus, the classification system 38 can predict that “San Francisco” is not a name.

In another example, the query “Michael Kitchen” has a valid first name, but not a valid last name. Web results, however, tend to be person oriented and contain context like “by veteran actor Michael Kitchen, best known” or “for fans of Michael Kitchen,” which suggests the string “Michael Kitchen” is a person's name. Thus, the classification system 38 can predict that “Michael Kitchen” is a name.

The self correcting mechanism 40 is desirably independent of the fast names exception database 34, “looks like a name” function 36, and the classification system 38. The self correcting mechanism 40 takes the output of the classification system 38 and the lists of first names and last names, and uses it to fix the lists of first names and last names used by each of the fast names exception database 34, “looks like a name” function 36 and classification system 38. The self correcting mechanism 40 typically uses the data output from the classification system 38 to learn about the list of first names 50 and the list of last names 52 so that it can make corrections.

For example, if classification system 38 is used to classify “black keyboard,” “wireless keyboard,” “ergonomic keyboard,” and “laptop keyboard,” all of which are not names, the self correcting mechanism will see that “keyboard” is in the last name position, however, since “keyboard” is associated with many negative classifications (that is, classifications that are non-names), the self correcting mechanism 40 will determine that “keyboard” is a possible error in the list of last names.

The self correcting mechanism 40 may also be used to determine that a name is missing from the predefined lists in the “looks like a name” function 36 or the fast names exception database 34. For example, if “Smith” is not included as a last name, but classification system 38 has seen that “Frank Smith” is a name, “Bee Smith” is a famous name, “black smith” is not a name, and “John Smith” is a famous name, the self correcting mechanism 40 can determine that “Smith” is a last name and add that to the last names list 52.

The output 42 may have one or more functions. For example, the output 42 can be used in a spell corrector to reduce overcorrection; the output 42 can also improve system relevance by using different algorithms if the query is a name; the output 42 can be used in name extraction; the output 42 can also be used for improved ad-triggering; the output 42 can be used to improved query analysis (a search engine can determine the percentage of queries for people and famous people); the output 42 can be combined with related extraction algorithms to improve document tagging to improve relevance; and/or, the output 42 can also detect when a user enters a vanity search (and not necessarily alter the relevance ranking).

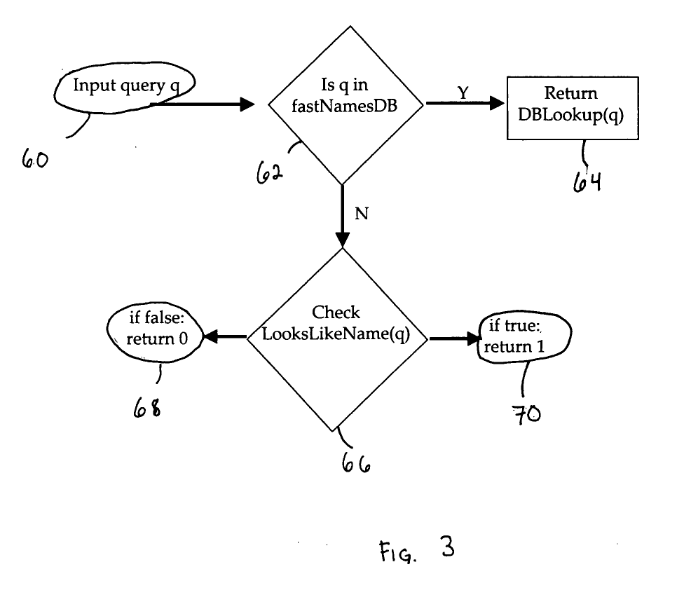

FIG. 3 illustrates the fast names algorithm in more detail. An input query q 32 is received at block 60. The process continues to block 62, where it is determined if the input query q 32 is in the fast names exception database 34. If the input query q 32 is in the fast names exception database 34, then the process continues to block 64, where a return database lookup is returned. The return database lookup is either a 0, 1 or f.

If the input query q 32 is not in the fast names exception database 34, the process continues to block 66, where the “looks like a name” function 36 is checked. If the “looks like a name” function 36 is false, the process proceeds to block 68 where a 0 (i.e., not a name) is returned. If the “looks like a name” function 36 is true, the process continues to block 70 where a 1 (i.e., is a name) is returned.

In one embodiment, the “looks like a name” function 36 determines the number of words in the query, and based on the number of words in the query, runs the query against one of a set of predefined templates. For example, if there are only two words in the query, the “looks like a name” function uses the template for two words which checks to see if the query is a first name (i.e., checks if the first word is in the first name list) followed by a last name (i.e., checks if the second word is in the last name list). In another example, if the query has three words, the looks like a function checks on of the following templates: first name, middle name, last name; prefix, first name, last name; first name, last name, suffix; prefix, initial, last name; or initial, initial, last name. Similar templates may be available for queries having four or five words, as well. Based on the result of the template check, the result of the “looks like a name” function 36 is either true or false.

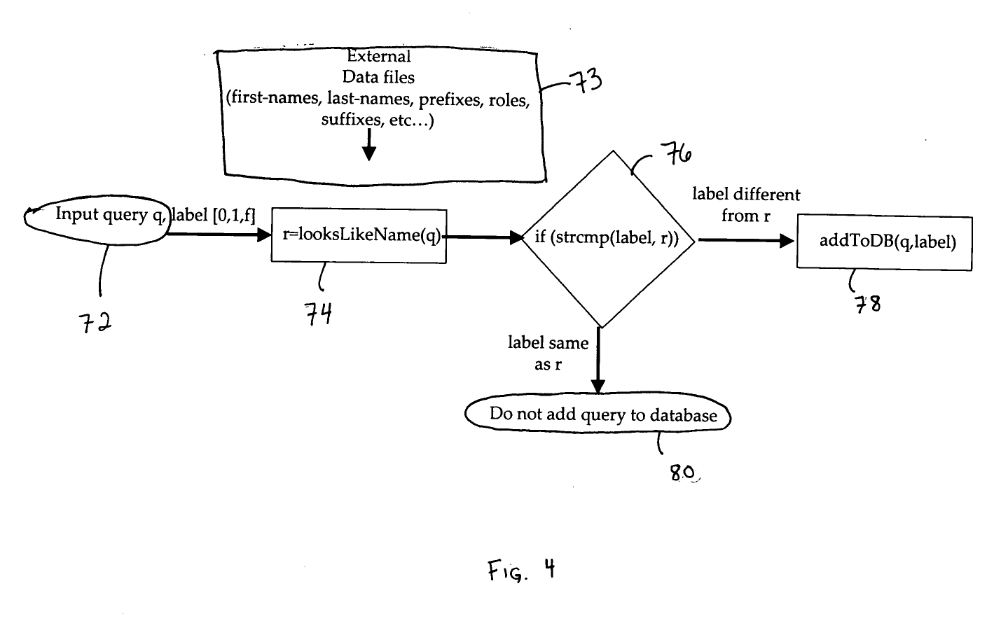

FIG. 4 illustrates a method for compressing the fast names exception database 34. The process begins at block 72 where an input query q is received. The input query q typically has a label of either 0 (i.e., not a name), 1 (i.e., name), or f (i.e., famous name). External data files such as, for example, lists of first names, last names, prefixes, roles, suffixes, etc. are received at block 73. The process continues to block 74 where the input query q and external data files are run against the “looks like a name” function (r) 36.

The process then continues to block 76 where the input query's label is compared to the output of the output of 74 (if(strcmp(label,r))). If the label is different than the answer from the “looks like a name” function 36, the process proceeds to block 78, where the input query q is added to the fast names exception database 34. If the label is the same as the answer from the “looks like a name” function 36, the process continues to block 80, where the input query q is not added to the fast names exception database 34.

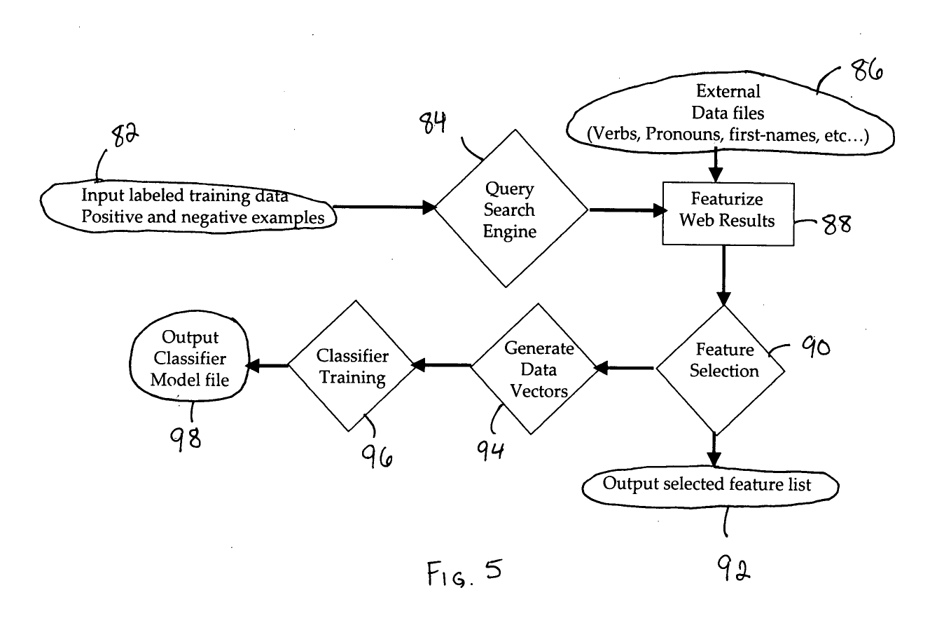

FIG. 5 shows a method of using the offline version 58 of the classification system 38. The offline version 58 of the classification system 38 may be used to train the online version 54 of the classifier 56.

The process begins at block 82 where input labeled training data is received. Both positive and negative examples are used as input at block 82. The process then continues to block 84 where the search engine is queried. External data files such as, for example, lists of verbs, pronouns, first names, and the like, are also received at block 86. The results from the search engine query at block 84 and the external data files input at block 86 are used to featurize web results at block 88. The web results are typically featurized by converting the website results into data, such as keywords, bigrams, tri-grams, etc. to produce a set of possible features.

The process then continues to block 90 where feature selection occurs. Typically, a statistical analysis of the set of possible features is performed to determine the features which are most likely to be important. That is, features that can be used to meaningfully differentiate between positive and negative results are selected. A selected features list is outputted at block 92. The process may also continue by generating data vectors at block 94. Data vectors are typically an ordered binary representation of the selected features list.

The process may then continue with classifier training at block 96: Typically, standard Support Vector Machine (SVM) tools are used. The process then continues to output a classifier model file at block 98.

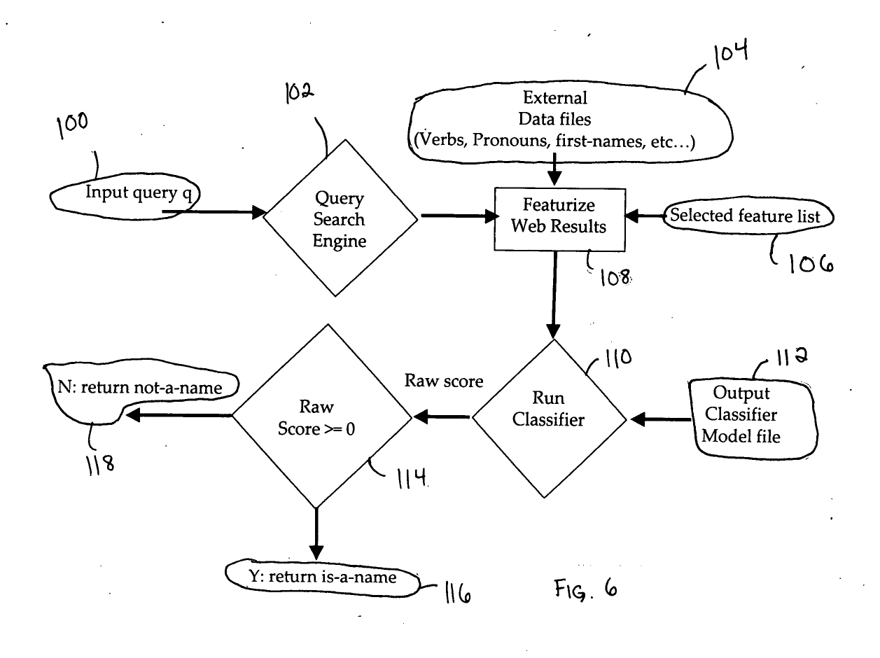

FIG. 6 shows a method for using the online version 54 of the classification system 38. In one embodiment, the online version 54 of the classification system 38 evaluates the input 32. Alternatively, the online version 54 of the classification system 38 evaluates other input, as described above.

The process begins at block 100 where an input query q is received. The input query q is sent to the search engine 14, which is queried at block 102. The results of the search engine query are combined with external data files such as, for example, lists of verbs, pronouns, first names, and the like, and a selected feature list (block 106), and are featurized as web results at block 108. The selected feature list is typically the selected feature list of FIG. 5.

The process continues by running the classifier 56 of the online version 54 of the classification system 38 at block 110. An output classifier model file 112 is input into the classifier 56 at block 110. In one embodiment, the classifier model file is the classifier model file created in FIG. 5. The classifier 56 produces a raw score. Typically, the classifier 56 includes a mapping between bit positions and a math function. The math function is typically based on the classifier model file. The raw score is produced using standard SVM classifying tools. If the raw score is greater than or equal to 0 at block 114, then the return is a name at block 116 (i.e., the label is 1). If the raw score less than 0 at block 114, then the return is not a name at block 118 (i.e., the label is 0). The classifier may also determine whether the input query q is a famous name.

Thus, the classifier 56 is used to create and add to the databases 44-48 of the fast names exception database 34.

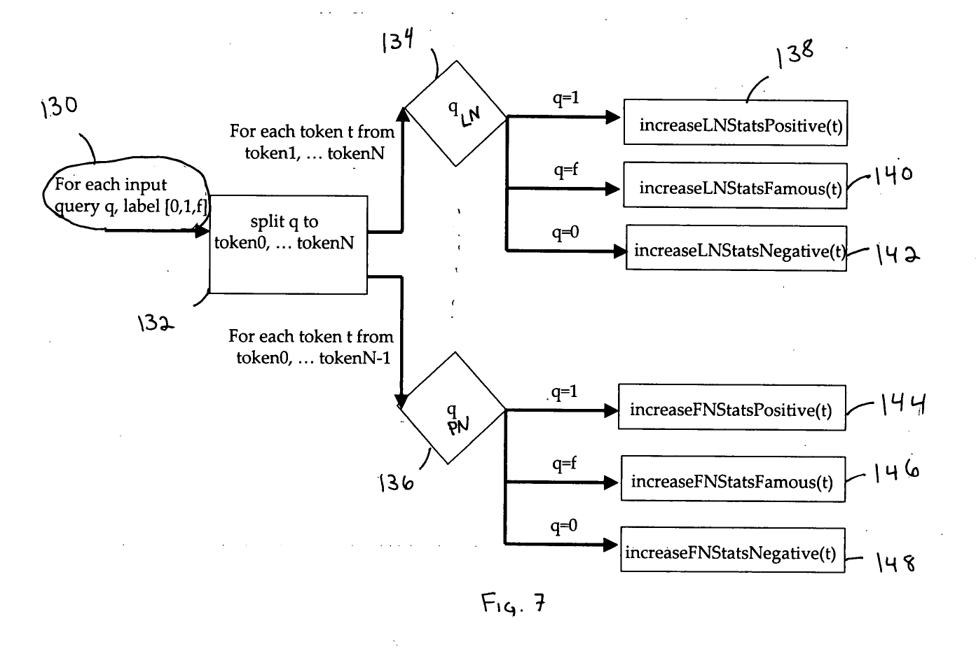

FIG. 7 shows a statistics generation phase for the self correcting mechanism 40. As will be discussed hereinafter, the self-correcting mechanism 40 uses the generated statistics to determine whether names should be removed from or added to the fast names exception database 34 or the lists in the “looks like a name” function 36.

The process begins with providing an input query q at block 130. A plurality of input queries (q1-qn) are provided. Each input query q is labeled 0, 1, or f. At block 132, the input query q is split into tokens ranging from token 0 to token n. The process continues to block 134 where, for each token t from token 1 . . . to token N, a value of q_{LN} (last name) is assigned. Similarly, at block 136, for each token t from token 0 . . . to token N−1, a value of q_{FN} (first name) is assigned.

For each value q_{LN 1}-q_{LN N}, the assigned value is either 1 (i.e., name), f (i.e., famous name), or 0 (i.e., not a name). If the q_{LN}=1, the last names stats positive is increased at block 138. At block 140, if q_{LN}=f, then the last name stats famous is increased. If q_{LN}=0, then, at block 142, the last name stats negative is increased.

Similarly, for each value q_{FN 0}-q_{FN N-1}, a value of 1 (i.e., name), f (i.e., famous name), or 0 (i.e., not a name) is assigned. If the q_{FN}=1, the first names stats positive is increased at block 144. At block 146, if q_{FN}=f, then the first name stats famous is increased. If q_{FN}=0, then, at block 148, the first name stats negative is increased.

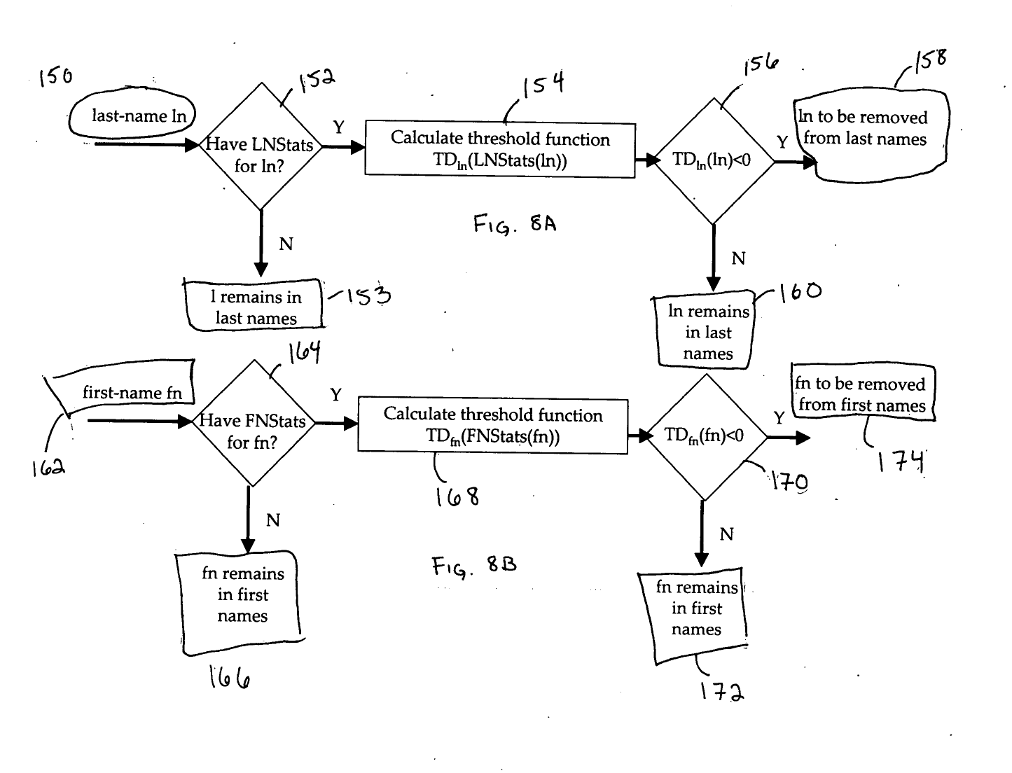

FIG. 8a illustrates a deletion phase of the self correcting mechanism for last names. Using the statistics generated at blocks 138, 140 and 142 of FIG. 8, the self-correcting mechanism 40 is able to determine whether any names should be deleted or removed from the databases 44-48.

The process begins at block 150 where a last name (ln) is provided. The process continues to block 152 where it is determined whether there are last name stats (LN stats) for the last name (ln). As discussed above, the last name stats are determined in the process shown in FIG. 7.

If there are no last name stats, then the last name remains in the last names exception database at block 153. If there are last name stats for the last name, the process continues to block 154, where a threshold function (TD_{LN} (LNStats (ln))) is calculated for the last name. The threshold function uses the statistics for both positive and negative classifications of a last name to determine whether the last name should be removed from the list. The threshold function is often a nonlinear function. That is, a larger number of negative classifications is treated differently than a small number of negative classifications. For example, two or more values can be used to determine whether a last name should be removed from the last name list based on the number of negative classifications.

The process continues to block 156, where it is determined if the threshold function value is less than 0. If the threshold function is less than 0, the process continues to block 158 where the last name is removed from the last names list. If the threshold function is greater than or equal to 0, the process continues to block 160, where the last name remains in the last names list.

FIG. 8b illustrates a deletion phase of the self correcting mechanism for first names. Using the statistics generated at blocks 144, 146 and 148 of FIG. 7, the self-correcting mechanism 40 is able to determine whether any names should be deleted or removed from the databases 44-48.

The process begins at block 162 by providing a first name (fn). The process continues to block 164 where it is determined if there are first name stats (FN stats) for the first name (fn). As discussed above, the first name stats are determined in the process shown in FIG. 7.

If there are no first name stats for the first name, the process continues to block 166 where the first name (fn) remains in the first names list. If there are first name stats for the first name, the process continues to block 168 where a threshold function (TD_{FN} (FNStats (fn))) is calculated for the first name. As discussed above with respect to FIG. 8a, the threshold function uses the statistics to determine whether the first name should be removed from the first name list.

The process continues to block 170 where it is determined if the value of the threshold function is less than 0. If the value is not less than 0, the process continues to block 172 where the first name remains in the first names list. If the value of the threshold function is less than 0, the process continues to block 174 where the first name is removed from the first names list.

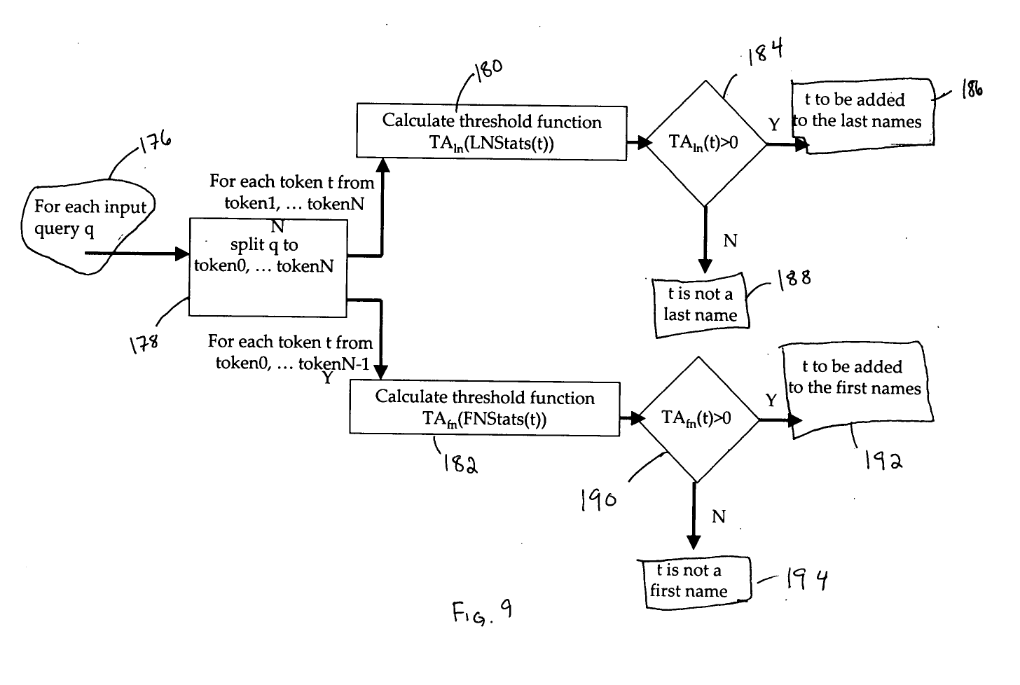

FIG. 9 illustrates an addition phase of the self correcting mechanism 40. The process begins at block 176 where input query q is provided. The process continues to block 178, where for each input query q provided, the input query q is split into tokens from token 0 to token N (token 1 . . . token N=LN and token 0 . . . token N−1=FN). For each token t from token 1 to token N, the process continues to block 180 where a threshold function (TA_{LN} (LNStats (t))) is calculated for last names. For each token from token 0 to token N−1, the process continues to block 182, where a threshold function (TA_{FN} (FNStats (t))) is calculated for first names. As with the threshold function for removing names (FIGS. 8a and 8b), the threshold function for adding names examines the negative and positive classification statistics for the first and last names to determine whether they should be added to the list. As with the threshold function for removing names, the threshold function for adding names is often non-linear, as well.

After calculating the threshold function at block 180 for last names, the process continues to block 184 where it is determined if the value of the last names threshold function is greater than 0. If the threshold function value is greater than 0, the process continues to block 186 where the token t is added to the last names list. If the value is not greater than 0, the process continues to block 188 where it is determined that the token t is not a last name.

After calculating the threshold function at block 182, the process continues to block 190 where it is determined if the value of the first name threshold function is greater than 0. If the first name threshold function value is greater than 0, the process continues to block 192 where the token t is to be added to the first names list. If the first name threshold function value is not greater than 0 the process continues to block 194 where it is determined that the token t is not the first name.

The systems and methods described herein are used to predict with very high accuracy if any given query is a name. The systems and methods combine offline classification with predefined lists to produce a very efficient database that can be used to predict if a query is a name within just a few CPU cycles.

The offline process (i.e., classification system 38) captures knowledge, which is compiled into a very efficient form (i.e., fast names exception database 34). This approach has been shown to have very high recall and precision with an overall accuracy of over 99% for person names for typical web search queries.

The system 30 is able to take a large group of classified queries and combine those with first name lists and last name lists and other predefined lists, such as lists of athletes, manual error corrections, lists of presidents and the like. The system 30 also uses original queries which may include actual user queries from a search engine, queries that are deemed important through click analysis over time and are likely to be names, and bi-grams extracted from the web where both words are capitalized.

The system 30 combines features of the query itself, each individual word of the query, and features extracted from the web results associated with the query which are parsed using a chart parser to get all possible combinations. Thus, the system 30 uses individual words, context, and speech tagging simultaneously to create an optimized algorithm for determining if a query is a name. By automatically combining classified queries with predefined lists, there is a higher accuracy than would be possible from either method alone.

For example, the names “Tupac” or “50 Cent” don't look like names. However, these names will be included in the original query list and will therefore be classified as famous names in the fast names exception database 34. And, if a person's name has never been queried but occurs on the web, then it will also be appropriately classified. In situations where there are proper nouns which can also be names, the system is able to determine whether the dominant meaning of the query is actually a name.

The systems and methods described herein have several advantages: the online fast names algorithm can run in well under 10 microseconds, can cover names that were never seen, and can recognize queries which don't look like a name. The systems and methods will also not miss queries which are not a name but look like a name. The systems and methods are able to use offline classification to provide the highest accuracy and efficient online algorithms to ensure the fastest possible speed. In addition, it is still able to achieve high accuracy, even when there are a few errors on the list. Since the system 30 is trained with real queries, the most popular queries have the highest chance of being correctly classified, even when the list has errors.

Another advantage of the systems and methods described herein is it is possible to identify not only if a query is a name, but also whether the name is a famous name. The systems and methods described herein begin with a large list of possible name queries and a list of first names and last names and a full flow offline classifier which runs using web results such as title summaries and URLs as well as the query itself to predict if each query is a name or not. The results are then supplemented with human edited lists of names and not names and the fast names exception database 34 is built. The highly compact fast names exception database 34, which is on the order of about 1 to 10 megabytes, is able to feed the fast names algorithm, which has the knowledge learned from the millions of training queries as well as the supplemental lists, thereby achieving superior accuracy and exceptional speed. The total complexity of running the fast names algorithm is typically on the order of 1000 CPU operations for a reasonable length query.

The online version 56 of the classification system 38 can be its own completely independent system that takes an input query and returns “is a name” or “is not a name” or “is famous” as output.

The online version 54 of classification system 38 may also be used for advertising purposes, such as, for example, by using ad triggering properties. Ad triggering is disclosed in U.S. patent application Ser. No. 11/200,799, entitled “A METHOD FOR TARGETING WORLD WIDE WEB CONTENT AND ADVERTISING TO A USER,” which is herein incorporated by reference.

In one embodiment, a separate corrections file can be used instead of the self-correcting mechanism 40, which can be built by a human who manually corrects classification errors.

The foregoing description with attached drawings is only illustrative of possible embodiments of the described method and should only be construed as such. Other persons of ordinary skill in the art will realize that many other specific embodiments are possible that fall within the scope and spirit of the present idea. The scope of the invention is indicated by the following claims rather than by the foregoing description. Any and all modifications which come within the meaning and range of equivalency of the following claims are to be considered within their scope.

What is claimed is:

1. A method of predicting if a query is a name comprising:
receiving a query;
searching a name database;
determining the query is a name if a match for the query is located in the name database; and
if the query is not located in the name database, determining if the query looks like a name.

2. The method of claim 1, wherein the query is a search engine search request.

3. The method of claim 1, wherein the name database includes a list of names, a list of not names and a list of famous names.

4. The method of claim 3, further comprising determining if the query is a famous name if the query is a name.

5. The method of claim 1, further comprising: if the query looks like a name, determining the query is a name.

6. The method of claim 5, wherein determining if the query looks like a name comprises:
parsing the query into at least a first part and a second part;
analyzing whether the first part matches a predefined list of first names;
analyzing whether the second part matches a predefined list of last names;
and if the first part matches the predefined list of first names and the second part matches the predefined list of last names, determining the query looks like a name.

7. The method of claim 5, wherein determining if the query looks like a name comprises:
determining a number of words in a query;
determining a predefined template corresponding to the number of words in the query; and
analyzing the query using the predefined template.

8. A method for generating a name database comprising:
storing a list of known names;
adding search queries known to be names to the list of known names; and
storing a list of known non-names.

9. The method of claim 8, further comprising classifying names as a famous name, a name or not a name.

10. The method of claim 8, further comprising removing from the list of known names search queries known to not be a name.

11. A method for determining if a query is a name comprising:
providing at least one query;
providing at least one web result for the at least one query;
analyzing the web result; and
generating features for the at least one query.

12. The method of claim 11, wherein the query is a search engine search request.

13. The method of claim 11, further comprising classifying the query as a name or not a name.

14. The method of claim 13, further comprising classifying the query as a famous name.

15. The method of claim 14, wherein the query is classified as a famous name by analyzing the frequency the query is asked by users.

16. The method of claim 14, wherein the query is classified as a famous name by a classifier, the classifier being trained to identify queries as being famous.

17. A method of classifying a name database comprising:
determining if a query is not a name;
determining if a query is a famous name; and
if the query is not a name, indexing the query as a non-name and if the query is a famous name, indexing the query as a famous name.

18. The method of claim 17, further comprising determining if a query looks like a name and indexing the query as a non-name if the query does not look like a name.

19. The method of claim 18, wherein determining if a query looks like a name comprises:
parsing the query into at least a first part and a second part;
analyzing whether the first part matches a predefined list of first names;
analyzing whether the second part matches a predefined list of last names;
and, if the first part matches the predefined list of first names and the second part matches the predefined list of last names, determining the query looks like a name.

20. The method of claim 17, wherein determining if a query is a famous name comprises:
submitting the query to a search engine to obtain a result; and
contextually analyzing the result.

21. A system for determining if an input is a name comprising:
a database comprising at least a list of names and a list of known non-names, the input being checked against at least the list of names and the list of known non-names in the database; and
a function for determining if the input is in the form of a name, the function comprising at least a list of first names, a list of last names, and a rule which checks the input against the list of first names and the list of last names.

22. The system of claim 21, wherein the database further comprises a list of famous names, the input being checked against the list of names, list of known non-names and the list of famous names.

23. The system of claim 21, further comprising:
a self-correcting mechanism for adding and removing names from the database, the list of first names and/or the list of last names.

24. The system of claim 21, further comprising:
a classifier for creating the database.
